(19) United States
(12) Patent Application Publication
(10) Pub. No.: US 2020/0084570 A1
(43) Pub. Date: Mar. 12, 2020

(54) METHOD AND DEVICE FOR SYNCHRONIZING A PARAMETER OF A MOVABLE DEVICE

(71) Applicant: SZ DJI TECHNOLOGY CO., LTD., Shenzhen (CN)

(72) Inventor: Zhuo GUO, Shenzhen (CN)

(21) Appl. No.: 16/685,418

(22) Filed: Nov. 15, 2019

Related U.S. Application Data
(63) Continuation of application No. PCT/CN2017/085517, filed on May 23, 2017.

(51) Int. Cl. H04W 4/02; G05D 1/10; H04N 5/232; H04W 4/38; H04J 3/06

(52) U.S. Cl. CPC H04W 4/02; G05D 1/10; H04J 3/06; H04W 4/38; H04N 5/23245

(57) ABSTRACT

A method for synchronizing a parameter of a movable device includes determining whether the movable device is connected with a smart device. The method also includes, based on a determination that the movable device is connected with the smart device, obtaining a target parameter of the smart device. The method further includes synchronizing the parameter of the movable device based on the target parameter, the parameter of the movable device corresponding to the target parameter.

### CROSS-REFERENCE TO RELATED APPLICATION

This application is a continuation application of International Application No. PCT/CN2017/085517, filed on May 23, 2017, the entire content of which is incorporated herein by reference.

### TECHNICAL FIELD

The present disclosure relates to the technology field of communication and, more particularly, to a method for synchronizing a parameter of a movable device and related device.

### BACKGROUND

A small unmanned aerial vehicle (“UAV”) often do not have a dedicated real time clock (“RTC”) battery for providing a reference time to a camera carried by the small UAV. As a result, when the UAV is not provided with a Global Positioning System (“GPS”) or is not connected with a smart device, the photographing or video recording cannot obtain the accurate time.

Because of the lack of a dedicated RTC battery to provide an accurate imaging time, when the UAV is not provided with the GPS or is not connected with a smart device, the UAV cannot obtain a date and/or time provided by an external device. The UAV has to provide a fixed or an inaccurate time to the camera. This may cause trouble to a user, such that a disorder in the time at which the photos and/or videos are captured, or a disorder in work products, etc.

### SUMMARY

In accordance with the present disclosure, there is provided a method for synchronizing a parameter of a movable device. The method includes determining whether the movable device is connected with a smart device. The method also includes, based on a determination that the movable device is connected with the smart device, obtaining a target parameter of the smart device. The method further includes synchronizing the parameter of the movable device based on the target parameter, the parameter of the movable device corresponding to the target parameter.

In accordance with the present disclosure, there is also provided a movable device. The movable device includes a controller configured to determine whether the movable device is connected with a smart device. The controller is also configured to, based on a determination that the movable device is connected with the smart device, obtain a target parameter of the smart device. The controller is further configured to synchronize a parameter of the movable device based on the target parameter, the parameter of the movable device corresponding to the target parameter.

According to the disclosed technical solutions, a determination may be made as to whether a movable device is connected with a smart device. If it is determined that the movable device is connected with the smart device, a target parameter of the smart device may be obtained. The target parameter may include a time parameter and/or a time-zone parameter. A parameter of the movable device may be synchronized based on the target parameter. The parameter of the movable device may correspond to the target parameter. When the movable device needs to synchronize the parameter, and when the movable device is connected with the smart device, the parameter of the movable device may be synchronized based on the parameter of the smart device. In some embodiments, parameter calibrations may be performed for the photos and/or videos captured by the movable device, to avoid the time disorder in the photos and/or videos captured by the movable device, or errors in work products, etc.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a flow chart illustrating a method for synchronizing a parameter of a movable device, according to an example embodiment.

FIG. 2 is a flow chart illustrating a method for synchronizing a parameter of a movable device, according to another example embodiment.

FIG. 3 is a schematic diagram of a control device, according to an example embodiment.

FIG. 4 is a schematic diagram of a control device, according to another example embodiment.

FIG. 5 is a schematic diagram of a hardware structure of a movable device, according to an example embodiment.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Example embodiments will be described with reference to the accompanying drawings, in which the same numbers refer to the same or similar elements unless otherwise specified.

Terms such as “first,” “second,” “third,” and “fourth” (if any) used in this specification and the claims are only used to distinguish different objects. These terms do not necessarily describe a specific order or sequence. It should be understood that data modified by such terms may be interchangeable in certain conditions, such that the embodiments described herein may be implemented in an order or sequence different from what is described or illustrated. The terms “including,” “comprising,” and “having” or any other variations are intended to encompass non-exclusive inclusion, such that a process, a method, a system, a product, or a device having a plurality of listed items not only includes these items, but also includes other items that are not listed, or includes items inherent in the process, method, system, product, or device.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for description. The term “unit” may encompass hardware and/or software components. For example, a “unit” may include a processor, a portion of a processor, an algorithm, a portion of an algorithm, a circuit, a portion of a circuit, etc.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed. The term “communicatively coupled” indicates that related items are coupled or connected through a communication chancel, such as a wired or wireless communication channel.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following descriptions explain example embodiments of the present disclosure, with reference to the accompanying drawings. Unless otherwise noted as having an obvious conflict, the embodiments or features included in various embodiments may be combined.

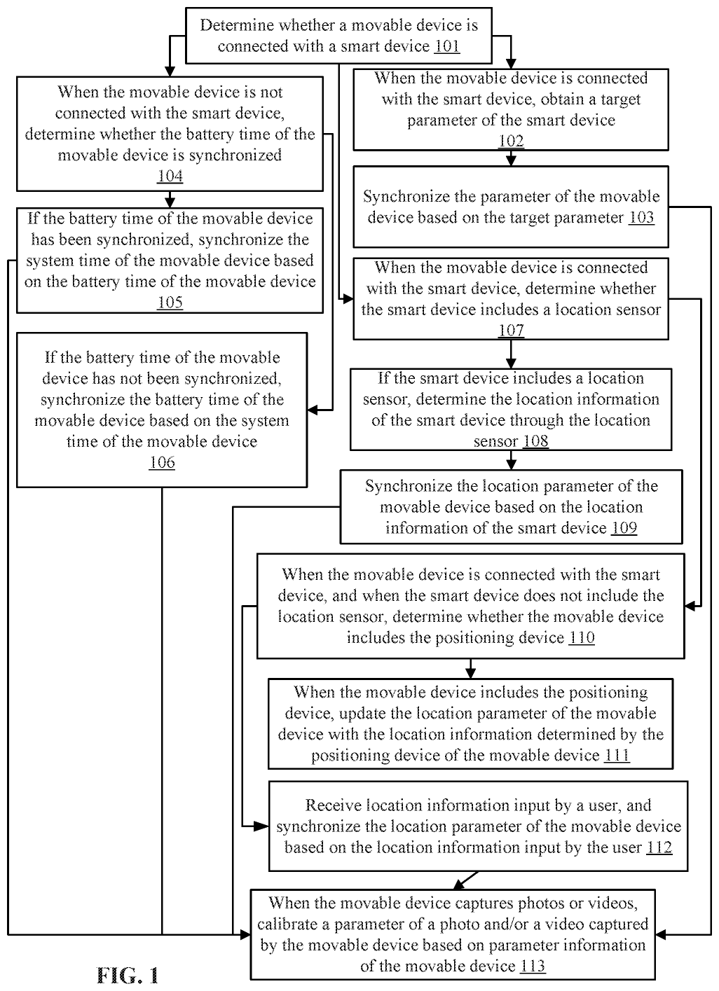

As shown in FIG. 1, an embodiment of the disclosed method for synchronizing a parameter of a movable device may include:

Step 101: determining whether the movable device is connected with a smart device.

In some embodiments, when the movable device needs to synchronize a parameter, whether the movable device is connected with a smart device may be determined.

In some embodiments, the execution entity for determining whether the movable device is connected with the smart device in step 101 may be an independent device for synchronizing the parameter of the movable device, or a controller of the movable device. The present disclosure does not limit the execution entity. In the following descriptions, the controller of the movable device is used as an example.

Step 102: when the movable device is connected with the smart device, the controller obtains a target parameter of the smart device.

In some embodiments, when the movable device is connected with the smart device, the controller may obtain the target parameter of the smart device. The target parameter may include at least one of a time parameter, a time zone parameter, or a location parameter.

Step 103: synchronizing the parameter of the movable device based on the target parameter.

In some embodiments, when the target parameter of the smart device obtained by the controller through step 102 includes a time parameter, the controller may synchronize the time parameter of the movable device based on the time parameter of the smart device. The time parameter of the movable device may include a system time parameter of the movable device and/or a battery time parameter of the movable device. The system time parameter and/or the battery time parameter of the movable device may be updated with the time of the smart device.

In some embodiments, when the target parameter obtained by the controller through step 102 includes a time zone parameter of the smart device, the controller may synchronize the time zone parameter of the movable device based on the time zone parameter of the smart device. The time zone information of the movable device may be updated with the time zone information of the smart device.

In some embodiments, the controller may determine whether the movable device is installed with a positioning device (such as a GPS). If the movable device is installed with the positioning device, the controller may determine the time zone parameter of the movable device based on the location information obtained by the positioning device of the movable device. For example, the controller may obtain the location of the movable device through the positioning device of the movable device, and determine the time zone of the movable device based on the location of the movable device.

Step 104: when the movable device is not connected with the smart device, determining whether the battery time of the movable device is synchronized.

In some embodiments, when the controller determines that the movable device is not connected with the smart device, the controller may determine whether the battery time of the movable device is synchronized. For example, the controller may determine whether the battery time of the movable device has been updated. The controller may compare the value of the battery time of the movable device with value of the system time of the movable device to determine whether the battery time of the movable device has been updated. When the battery time has been synchronized, step 105 may be executed. When the battery time has not been synchronized, step 106 may be executed.

Step 105: if the battery time of the movable device has been synchronized, synchronizing the system time of the movable device based on the battery time of the movable device.

In some embodiments, when the battery time of the movable device has been synchronized, i.e., when the battery time of the movable device is greater than the system time of the movable device, the controller may determine that the battery time of the movable device is continuously counting. The controller may determine that the battery time of the movable device is accurate relative to the system time of the movable device. The system time of the movable device may be updated with the battery time of the movable device, such that the system time of the movable device and the battery time of the movable device are synchronized.

Step 106: if the battery time of the movable device has not been synchronized, synchronizing the battery time of the movable device based on the system time of the movable device.

In some embodiments, when the battery time of the movable device has not been synchronized, then the battery time of the movable device may be smaller than the system time of the movable device. The controller may determine that the battery time of the movable device is not counting. The controller may determine that the system time of the movable device is accurate relative to the battery time of the movable device. The battery time of the movable device may be updated with the system time of the movable device, such that the battery time of the movable device and the system time of the movable device are synchronized.

Step 107: when the movable device is connected with the smart device, the controller may determine whether the smart device includes a location sensor. If the smart device includes a location sensor, steps 108-109 may be executed. If the smart device does not include a location sensor, steps 110-112 may be executed.

Step 108: if the smart device includes a location sensor (e.g., a GPS sensor), the controller may determine the location information of the smart device through the location sensor of the smart device.

Step 109: synchronizing the location parameter of the movable device based on the location information of the smart device.

In some embodiments, when the controller determines the location information of the smart device through the location sensor of the smart device, the controller may update the location parameter of the movable device with the location parameter of the smart device.

In some embodiments, when the movable device is not connected with the smart device, the controller may determine whether the movable device is installed with a positioning device. When the movable device is installed with the positioning device, the location parameter of the movable device may be synchronized based on the location information determined by the positioning device of the movable device. When the movable device is not installed with the positioning device, location information may be input by a user, and the location parameter of the movable device may be synchronized based on the location information input by the user.

In some embodiments, the location parameter may include a latitude and longitude coordinate system, a geographical location name, or other suitable form, as long as the location can be displayed. The present disclosure does not limit the location parameter.

Step 110: when the movable device is connected with the smart device, and when the smart device does not include the location sensor, the controller may determine whether the movable device includes the positioning device. If the movable device includes the positioning device, step 111 may be executed. If the movable device does not include the positioning device, step 112 may be executed.

Step 111: when the movable device includes the positioning device (e.g., GPS), the location parameter of the movable device may be updated with the location information determined by the positioning device of the movable device.

Step 112: when the movable device does not include the positioning device (e.g., when the positioning device of the movable device cannot receive signals due to being indoor or other obstacles that block the signals), the controller may receive location information input by a user, and may synchronize the location parameter of the movable device based on the location information input by the user. For example, the location parameter of the movable device may be updated with the location information input by the user.

In some embodiments, through steps 102-103, the time parameter and/or the time zone parameter of the movable device may be synchronized when the movable device is connected with the smart device. Through steps 104-106, the battery time and the system time of the movable device may be synchronized when the movable device is not connected with the smart device. Through steps 107-112, the location parameter of the movable device may be synchronized when the movable device is connected with the smart device. The steps need not necessarily be executed in the described order. For example, steps 102-103 may be executed first, or steps 104-106 may be executed first, or steps 107-112 may be executed first. In some embodiments, these steps may be simultaneously executed. The present disclosure does not limit the order of executing these steps.

In some embodiments, the target parameter may include other parameters, such as sensible external parameters, obtainable broadcasting signal parameters, etc.

Correspondingly, the target parameter may be determined and synchronized.

Step 113: when the movable device captures photos or videos, the controller may calibrate a parameter of a photo and/or a video captured by the movable device based on parameter information of the movable device.

As seen from above, through different methods, the controller may synchronize the parameter information of the movable device when the movable device is connected with the smart device or is not connected with the smart device. In addition, the controller may calibrate one or more parameters of the one or more photos and/or videos captured by the movable device, such that the time of the photos and/or videos captured by the movable device is correct, thereby avoid any time error.

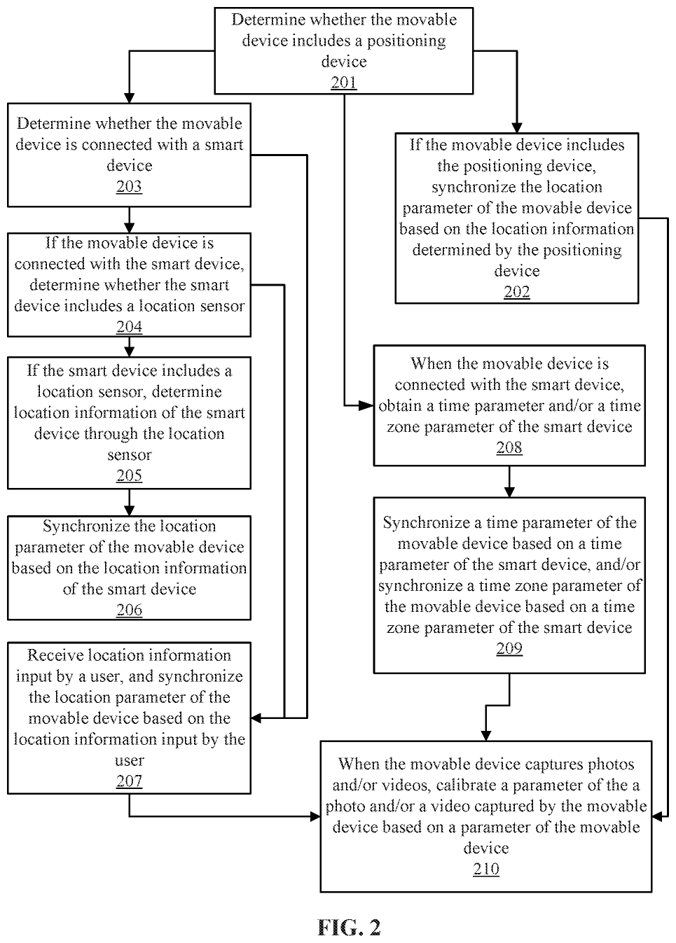

As shown in FIG. 2, another embodiment of the disclosed method for synchronizing a parameter of the movable device may include:

Step 201: when the controller determines the location parameter of the movable device, the controller determines whether the movable device includes a positioning device (e.g., a GPS device). If the movable device includes a positioning device, step 202 may be executed. If the movable device does not include the positioning device, step 203 may be executed.

Step 202: if the movable device includes the positioning device, the controller may synchronize the location parameter of the movable device based on the location information determined by the positioning device. For example, when the movable device includes the positioning device, the location parameter of the movable device may be updated based on the location information determined by the positioning device.

Step 203: determining whether the movable device is connected with a smart device.

In some embodiments, when the movable device is located indoor or is blocked by buildings such that the positioning device of the movable device cannot receive signals, the controller may determine whether the movable device is connected with a smart device. If the movable device is connected with the smart device, step 204 may be executed. If the movable device is not connected with the smart device, step 207 may be executed.

Step 204: if the movable device is connected with the smart device, the controller may determine whether the smart device includes a location sensor (e.g., a GPS sensor). If the smart device includes a location sensor, steps 205-206 may be executed. If the smart device does not include a location sensor, step 207 may be executed.

Step 205: if the smart device includes a location sensor, determining location information of the smart device through the location sensor of the smart device.

When the controller determines that the smart device includes a location sensor, the controller may determine a geographical location of the smart device through the location sensor of the smart device, to obtain the location information of the smart device.

Step 206: synchronizing the location parameter of the movable device based on the location information of the smart device.

When the controller determines the location information of the smart device, the controller may update the location parameter of the movable device with the location information of the smart device, such that when the location parameter of the movable device is subsequently used, a more accurate location may be provided.

Step 207: when the smart device does not include a location sensor, the controller may receive location information input by a user, and may synchronize the location parameter of the movable device based on the location information input by the user. For example, the controller may update the location parameter of the movable device with the location information input by the user.

Step 208: when the movable device is connected with the smart device, the controller may obtain a time parameter and/or a time zone parameter of the smart device through the smart device, such as 9:45 A.M. in the morning and/or UTC+8 time zone (e.g., Beijing time zone).

Step 209: after the controller obtains the time parameter and the time zone parameter of the smart device through step 208, the controller may synchronize the time parameter of the movable device based on the time parameter of the smart device. The time parameter of the movable device may include a system time parameter of the movable device and/or a battery time parameter of the movable device. For example, the system time and/or the battery time of the movable device may be updated with the time of the smart device. In some embodiments, the time zone parameter of the movable device may be synchronized with the time zone parameter of the smart device. For example, the time zone of the movable device may be updated with the time zone of the smart device.

In some embodiments, through step 202, the location parameter of the movable device may be synchronized when the movable device includes the positioning device. Through steps 203-207, the location parameter of the movable device may be synchronized when the movable device does not include the positioning device and when the movable device is connected with the smart device. Through steps 208-209, the time parameter and/or the time zone parameter of the movable device may be synchronized. However, these steps may not be necessarily executed in the described order. Any suitable order may be used. For example, in some embodiments, step 202 may be first executed. In some embodiments, steps 203-207 may be first executed. In some embodiments, steps 208-209 may be first executed. In some embodiments, these steps may be executed simultaneously. The present disclosure does not limit the order of execution of these steps.

Step 210: when the movable device captures photos and/or videos, calibrating a parameter of a photo and/or a video captured by the movable device based on a parameter of the movable device.

In some embodiments, when the movable device captures photos and/or videos, the controller may calibrate one or more parameters of one or more photos and/or videos based on the time parameter, time zone parameter, and/or location parameter of the movable device. For example, a calibrated imaging time, time zone, and/or location information may be marked at a corner of a photo and/or a video.

In some embodiments, as seen above, through different methods, the controller may synchronize the location parameter of the movable device whether the movable device receives positioning signals or does not receive positioning signals, such that a new location parameter may be obtained. The controller may also synchronize the time parameter and/or the time zone parameter of the movable device, and calibrate a parameter of a photo and/or a video captured by the movable device, such that the time and location information of the photo and/or video captured by the movable device is correct. Errors in the time and/or location information may be avoided.

The above describes the embodiments of the present disclosure from the perspective of a method for synchronizing a parameter of the movable device. Next, the embodiments of the present disclosure will be described from the perspective of the controller.

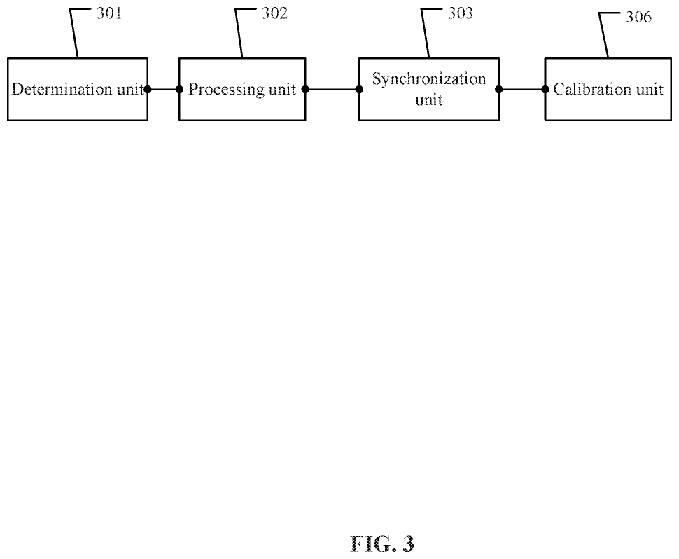

The present disclosure provides a controller. The controller may execute the method for synchronizing a parameter of the movable device as shown in the embodiment of FIG. 1. The detailed structure of the controller will be described below with reference to FIG. 3.

The controller may include:

a determination unit 301 configured to determine whether the movable device is connected with a smart device;

a processing unit 302 configured to obtain a target parameter of the smart device when the movable device is connected with the smart device;

a synchronization unit 303 configured to synchronize a parameter of the movable device based on the target device, the parameter of the movable device being corresponding to the target parameter; and

a calibration unit 304 configured to calibrate a parameter of a photo and/or a video captured by the movable device based on parameter information of the movable device.

In some embodiments, the processing unit 302 may be configured to obtain the time parameter of the smart device.

In some embodiments, the synchronization unit 303 may be configured to synchronize the time parameter of the movable device based on the time parameter of the smart device when the processing unit 302 obtains the time parameter of the smart device, the time parameter of the movable device including a system time parameter and/or a battery time parameter of the movable device.

In some embodiments, the processing unit 302 may be configured to obtain a time zone parameter of the smart device.

In some embodiments, the synchronization unit 303 may be configured to synchronize the time zone parameter of the movable device based on the time zone parameter of the smart device when the processing unit 302 obtains the time zone parameter of the smart device.

In some embodiments, the synchronization unit 303 may be configured to synchronize the time zone parameter of the movable device based on location information determined by the positioning device of the movable device, when the movable device includes the positioning device and when the target parameter includes a time zone parameter.

In some embodiments, the processing unit 302 may be configured to determine location information of the smart device based on a location sensor of the smart device, when the movable device is connected with the smart device, when the target parameter includes a location parameter, and when the smart device includes the location sensor.

In some embodiments, the synchronization unit 303 may be configured to synchronize a location parameter of the movable device based on location information of the smart device, when the processing unit 302 determines location information of the smart device based on the location sensor of the smart device.

In some embodiments, the synchronization unit 303 may be configured to synchronize a location parameter of the movable device based on the location information determined by the positioning device when the smart device does not include a location sensor, and when the movable device includes the positioning device.

In some embodiments, the processing unit 302 may receive location information input by a user when the smart device connected with the movable device does not include a location sensor, and when the movable device does not include a positioning device. The synchronization unit 303 may be configured to synchronize the location parameter of the movable device based on the location information input by the user.

In some embodiments, the synchronization unit 303 may be configured to synchronize the system time of the movable device based on the battery time of the movable device when the movable device is not connected with the smart device and when the battery time of the movable device has been synchronized.

In some embodiments, the synchronization unit 303 may be configured to synchronize the battery time of the movable device based on the system time of the movable device when the battery time of the movable device has not been synchronized.

In some embodiments, the synchronization unit 303 may be configured to synchronize a time zone parameter of the movable device based on a time zone parameter determined by the positioning device, when the movable device is not connected with the smart device, and when the movable device includes the positioning device.

In some embodiments, the processing unit 302 may be configured to receive time zone information input by the user, when the movable device does not include the positioning device and when the smart device connected with the movable device does not include the location sensor. The synchronization unit 303 may be configured to synchronize the time zone parameter of the movable device based on the time zone information input by the user.

The interaction methods between the various modules and units of the device for synchronizing parameters are similar to those described above in connection with FIG. 1, and are not repeated.

As can be seen from above descriptions, through various methods, the controller may synchronize parameter information of the movable device when the movable device is or is not connected with a smart device. In addition, the controller may calibrate a parameter of a photo and/or a video captured by the movable device, such that the time of the photo and/or video captured by the movable device is correct. Errors in the time information of the photos and/or videos can be avoided.

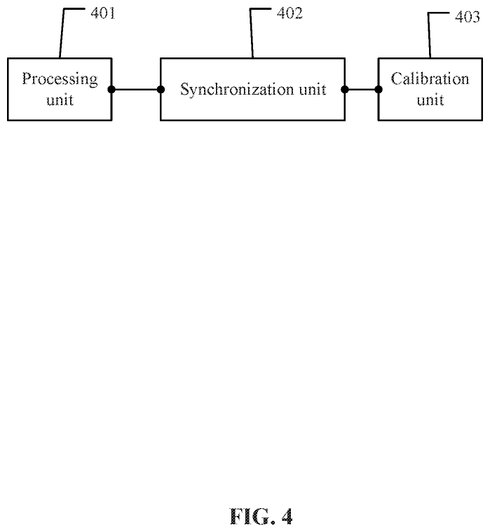

In some embodiments, the present disclosure provides a controller. The controller may be configured to execute the method for synchronizing a parameter of the movable device, as shown in FIG. 2. The detailed structure of the controller will be described below with reference to FIG. 4.

The controller may include:

a processing unit 401 configured to determine whether the movable device includes a positioning device;

a synchronization unit 402 configured to synchronize a location parameter of the movable device based on location information determined by the positioning device of the movable device, when the movable device includes the positioning device; and

a calibration unit 403 configured to calibrate a parameter of a photo and/or a video based on parameter information of the movable device, when the movable device captures photos and/or videos.

In some embodiments, the processing unit 401 may be configured to determine whether the smart device includes a location sensor, when the movable device does not include the positioning device, and when the movable device is connected with the smart device. When the smart device includes the location sensor, the processing unit 401 may obtain location information of the smart device based on the location sensor.

In some embodiments, the synchronization unit 402 may be configured to synchronize a location parameter of the movable device based on the location information of the smart device, when the processing unit 401 obtains the location information of the smart device based on the location sensor.

In some embodiments, the processing unit 401 may be configured to obtain a time parameter of the smart device when the movable device is connected with the smart device.

In some embodiments, the synchronization unit 402 may be configured to synchronize a time parameter of the movable device based on a time parameter of the smart device when the processing unit 401 obtains the time parameter of the smart device.

Additionally or alternatively, the processing unit 401 may be configured to obtain a time zone parameter of the smart device.

The synchronization unit 402 may be configured to synchronize the time zone parameter of the movable device based on the time zone parameter of the smart device when the processing unit 401 obtains the time zone parameter of the smart device.

In some embodiments, the processing unit 401 may be configured to receive location information input by a user when the smart device does not include the location sensor. The synchronization unit 402 may be configured to synchronize the location parameter of the movable device based on the location information input by the user.

The interaction methods between the various modules and/or units of the device for synchronizing a parameter of the movable device can refer to the descriptions of the embodiment shown in FIG. 2, which are not repeated.

As can be seen from the above descriptions, through various methods, the controller may synchronize the location parameter of the movable device whether or not the movable device can receive positioning signals, to obtain a new location parameter. The controller may be configured to synchronize the time parameter and/or the time zone parameter of the movable device. Further, the controller may be configured to calibration a parameter of a photo and/or a video captured by the movable device, such that the time is correct for the photo and/or video captured by the movable device. Errors in the time information of the photos and/or videos can be avoided.

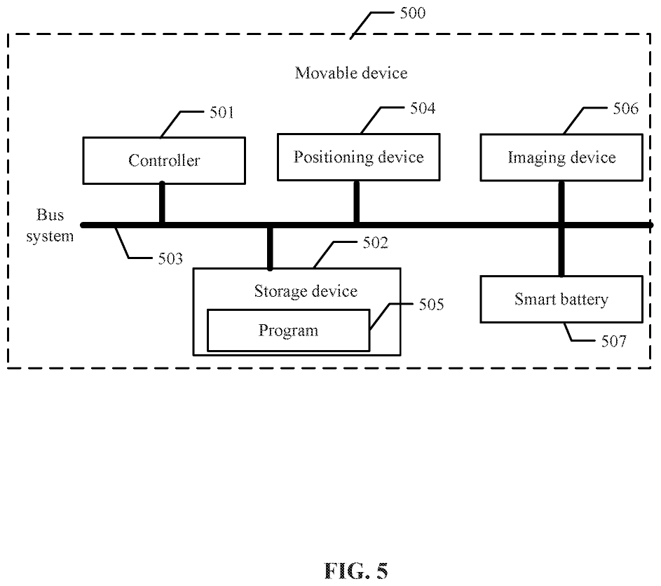

FIG. 5 shows a schematic diagram of a hardware structure of the movable device. As shown in FIG. 5, a movable device 500 may have different properties based on different configurations and/or performances. The movable device may include:

one or more controllers 501, a storage device 502, a bus system 503, a positioning device 504, an imaging device 506, and a smart battery 507. The controller 501, storage device 502, positioning device 504, the imaging device 506, and the smart battery 507 may be connected with one another through the bus system 503.

In some embodiments, the storage device 502 may be configured to store a computer program 505. The controller 501 may retrieve the program 505 stored in the storage device 502 to execute the steps of the method shown in FIG. 1 that are executed by the controller. In some embodiments, the controller 501 may include multiple units or modules configured to execute the steps of the method shown in FIG. 2. The interaction methods between the various modules and/or units are shown in FIG. 2, which are not repeated.

In some embodiments, the positioning device 504 may be configured to provide positioning service to the movable device 500.

In some embodiments, the imaging device 506 may be communicatively connected with the controller 501, and may be controlled by the controller 501 to capture photos and/or videos.

In some embodiments, the smart battery 507 may be communicatively connected with the controller 501. The smart battery 507 may be provided with a counter configured to calculate or count the time of the smart battery 507.

A person having ordinary skills in the art can appreciate that for simplicity and convenience, the detailed operations of the above-described system, device, and unit can refer to the corresponding descriptions of the processes of the various embodiments of the disclosed methods, which are not repeated.

The present disclosure provides a non-transitory computer storage medium configured to store program codes or instructions. The program codes or instructions may be executed to instruct various devices, systems, or components to perform the disclosed methods for controlling the movable device.

A person having ordinary skill in the art can appreciate that the above embodiments are only examples of the present disclosure, which are described for the better understanding of the present disclosure, and do not limit the scope of the present disclosure.

A person having ordinary skill in the art can appreciate that part or all of the above disclosed methods and processes may be implemented using related electrical hardware, computer software, or a combination of electrical hardware and computer software that may control the electrical hardware. To illustrate the exchangeability of the hardware and software, in the above descriptions, the configurations and steps of the various embodiments have been explained based on the functions performed by the hardware and/or software. Whether the implementation of the functions is through hardware or software is to be determined based on specific application and design constraints. A person having ordinary skill in the art may use different methods to implement the functions for different applications. Such implementations do not fall outside of the scope of the present disclosure.

A person having ordinary skill in the art can appreciate that the various system, device, and method illustrated in the example embodiments may be implemented in other ways. For example, the disclosed embodiments for the device are for illustrative purpose only. Any division of the units are logic divisions. Actual implementation may use other division methods. For example, multiple units or components may be combined, or may be integrated into another system, or some features may be omitted or not executed. Further, couplings, direct couplings, or communication connections may be implemented using indirect coupling or communication between various interfaces, devices, or units. The indirect couplings or communication connections between interfaces, devices, or units may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. Some or all of the units or components may be selected to implement the disclosed embodiments based on the actual needs of different applications.

Various functional units or components may be integrated in a single processing unit, or may exist as separate physical units or components. In some embodiments, two or more units or components may be integrated in a single unit or component.

If the integrated units are realized as software functional units and sold or used as independent products, the integrated units may be stored in a computer-readable storage medium. Based on such understanding, the portion of the technical solution of the present disclosure that contributes to the current technology, or some or all of the disclosed technical solution may be implemented as a software product. The computer software product may be storage in a non-transitory storage medium, including instructions or codes for causing a computing device (e.g., personal computer, server, or network device, etc.) to execute some or all of the steps of the disclosed methods. The storage medium may include any suitable medium that can store program codes or instruction, such as at least one of a U disk (e.g., flash memory disk), a movable hard disk, a read-only memory (“ROM”), a random access memory (“RAM”), a magnetic disk, or an optical disc.

The above descriptions only illustrate some embodiments of the present disclosure. The present disclosure is not limited the described embodiments. A person having ordinary skill in the art may conceive various equivalent modifications or replacements based on the disclosed technology. Such modification or improvement also fall within the scope of the present disclosure. A true scope and spirit of the present disclosure are indicated by the following claims.

What is claimed is:

1. A method for synchronizing a parameter of a movable device, comprising:
determining whether the movable device is connected with a smart device;
based on a determination that the movable device is connected with the smart device, obtaining a target parameter of the smart device; and
synchronizing the parameter of the movable device based on the target parameter, the parameter of the movable device corresponding to the target parameter.

2. The method of claim 1,
wherein obtaining the target parameter of the smart device comprises obtaining a time parameter or a time zone parameter of the smart device, and
wherein synchronizing the parameter of the movable device based on the target parameter comprises:
synchronizing a time parameter or a time zone parameter of the movable device based on the time parameter or the time zone parameter of the smart device, the time parameter of the movable device comprising at least one of a system time parameter or a battery time parameter of the movable device.

3. The method of claim 1, further comprising:
based on a determination that the target parameter comprises a time zone parameter, and that the movable device includes a positioning device, determining a time zone parameter of the movable device based on location information determined by the positioning device.

4. The method of claim 1, wherein when the movable device is connected with the smart device, the method further comprises:
based on a determination that the target parameter includes a location parameter, and that the smart device includes a location sensor, determining a location parameter of the smart device based on the location sensor,
wherein synchronizing the parameter of the movable device based on the target parameter comprises synchronizing a location parameter of the movable device based on the location parameter of the smart device.

5. The method of claim 1, wherein when the smart device does not include a location sensor, the method further comprises:
based on a determination that the movable device includes a positioning device, determining a location parameter of the movable device based on location information determined by the positioning device of the movable device.

6. The method of claim 1, wherein when the movable device does not include a positioning device, the method further comprises:
receiving location information or time zone information input by a user; and
synchronizing the location parameter of the movable device based on the location information input by the user, or synchronizing a time zone parameter of the movable device based on the time zone information input by the user.

7. The method of claim 1, wherein when the movable device is not connected with the smart device, the method further comprises:
based on a determination that a battery time of the movable device has been synchronized, synchronizing a system time of the movable device based on the battery time of the movable device.

8. The method of claim 1, further comprising:
based on a determination that a battery time of the movable device has not been synchronized, synchronizing the battery time of the movable device based on a system time of the movable device.

9. The method of claim 1, wherein when the movable device is not connected with the smart device, the method further comprises:
based on a determination that the movable device includes a positioning device, synchronizing a time zone parameter of the movable device based on time zone information determined by the positioning device of the movable device.

10. The method of claim 1, further comprising:
when the movable device captures at least one of a photo or a video, calibrating a parameter of the at least one of the photo or the video captured by the movable device based on parameter information of the movable device.

11. A movable device, comprising:
a controller configured to:
determine whether the movable device is connected with a smart device;
based on a determination that the movable device is connected with the smart device, obtain a target parameter of the smart device; and
synchronize a parameter of the movable device based on the target parameter, the parameter of the movable device corresponding to the target parameter.

12. The movable device of claim 11, further comprising:
a battery communicatively connected with the controller, the battery comprising a counter function,
wherein the controller is configured to:
obtain a time parameter or a time zone parameter of the smart device; and
synchronize a time parameter or a time zone parameter of the movable device based on the time parameter or the time zone parameter of the smart device, the time parameter of the movable device comprising at least one of a system time parameter of the movable device or a battery time parameter of the movable device.

13. The movable device of claim 11, further comprising:
a positioning device communicatively connected with the controller,
wherein the controller is configured to determine a time zone parameter of the movable device based on location information determined by the positioning device when the target parameter comprises a time zone parameter.

14. The movable device of claim 11, wherein the controller is configured to:
based on a determination that the movable device is connected with the smart device, that the smart device includes a location sensor, and that the target parameter comprises a location parameter, determine location information of the smart device based on the location sensor, and synchronize a location parameter of the movable device based on the location information of the smart device.

15. The movable device of claim 11, wherein the controller is configured to:
based on a determination that the smart device does not include a location sensor, and that the movable device includes a positioning device, synchronize a location parameter of the movable device based on a location parameter determined by the positioning device.

16. The movable device of claim 11, wherein the controller is configured to:
based on a determination that the movable device does not include a positioning device, receive location information or time zone information input by a user, and synchronize a location parameter of the movable device based on the location information input by the user, or synchronizing a time zone parameter of the movable device based on the time zone information input by the user.

17. The movable device of claim 11, wherein the controller is configured to:
based on a determination that the movable device is not connected with the smart device, and that a battery time of the movable device has been synchronized, synchronize a system time of the movable device based on the battery time of the movable device.

18. The movable device of claim 11, wherein the controller is configured to:
based on a determination that a battery time of the movable device has not been synchronized, synchronize the battery time of the movable device based on a system time of the movable device.

19. The movable device of claim 11, wherein the controller is configured to:
based on a determination that the movable device is not connected with the smart device, and that the movable device includes a positioning device, synchronize a time zone parameter of the movable device based on a time zone parameter determined by the positioning device.

20. The movable device of claim 11, further comprising:
an imaging device communicatively connected with the controller,
wherein the controller is configured to control the imaging device to capture at least one of a photo or a video, and to calibrate a parameter of the at least one of the photo or the video captured by the imaging device based on parameter information of the movable device.
